(19) United States
(12) Patent Application Publication
(10) Pub. No.: US 2007/0127982 A1
(43) Pub. Date: Jun. 7, 2007

(54) Device for pivotably connecting at least two components and a method for mounting the device

(75) Inventors: Jens Bohlen, Eyendorf (DE); Hans-Joachim Hurschler, Ellerbek (DE); Thomas Krueger, Buchholz in der Nordheide (DE); Jan Maak, Seevetal (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/598,685

(22) Filed: Nov. 14, 2006

(30) Foreign Application Priority Data
Nov. 15, 2005 (DE) 102005054461.4

(51) Int. Cl. F16C 11/06

(52) U.S. Cl. 403/119; 29/428; 403/24; 403/409.1

(57) ABSTRACT

A device for the detachable and pivotable connection of at least two components and a method for mounting the device are provided. The device includes a bolt on a first component that engages through a through-opening in a second component. The through-opening has a centering section into which a centering bushing is plugged. The centering bushing is pressed onto the centering section in order to set a defined frictional torque between the first and second components with a predefined axial force. To secure the axial position of the centering bushing, a locking element is provided, which is plugged onto the bolt and has a receptacle for the bolt. Both the circumferential surface of the bolt and the internal surface of the receptacle are provided, in at least one axial section, with a profile for forming a circular wedge connection through a relative rotational movement between the bolt and the receptacle.

### CROSS REFERENCE TO RELATED APPLICATIONS

This application claims priority under 35 U.S.C. §119 to German Patent Application No. 102005054461.4, filed Nov. 15, 2005, the entire disclosure of which is herein expressly incorporated by reference.

### BACKGROUND AND SUMMARY OF THE INVENTION

The present invention relates to a device for detachably and pivotably connecting at least two components and a method for mounting the device.

Steering column arrangements for motor vehicles including an adjustment device for adjusting the inclination of a pivotably coupled steering column jacket of a steering spindle are known. The inclination adjustment device has at least one lever, which is pivotably connected to the steering column jacket by at least one articulated connection, which is approximately free of play in the axial and radial directions viewed in the direction of the pivoting axis. The resulting flexural torque values of the components which are pivotably connected to one another are adjustable with respect to one another. To form this articulated connection, it is known to couple the components to one another with a rivet connection or screw/nut connection. The rivet connection has, inter alia, the disadvantage that the components cannot be separated from one another without destroying the rivet connection. A disadvantage with the screw/nut connection is that the flexural torque acting between the components cannot be freely adjusted, due to the necessary tightening torque/securing torque of the nut.

An object of the present invention is to provide a device in which an articulated connection can be produced that is play-free in the axial and radial directions between at least two components, which are to be connected to one another in a pivotable fashion. Furthermore, the resulting flexural torque values of the components can be adjusted with respect to one another, and the securing force values of the connection can be set independently of one another, as a function of process parameters. A further object of the invention is to specify a method for mounting the device.

To achieve the above-mentioned object, the invention provides a device is proposed which has a bolt that serves as an axis of rotation and is disposed on the first component. In the mounted state of the device, the bolt engages through a through-opening in the second component, which may include play. The through-opening may have a conical centering section into which a centering bushing plugged onto the bolt is arranged to align or center the components with respect to one another. For this purpose, the centering bushing may have an external contour or external contour section designed to be complementary to the internal contour of the centering section.

The centering bushing is pressed onto the centering section to set a defined frictional torque/flexural torque between the first and second components with a predefined axial force. To secure the axial position of the centering bushing to which axial force is applied, a locking element is provided, which is plugged onto the bolt and which has a receptacle for the bolt. Both the circumferential surface of the bolt and the internal surface of the receptacle are provided, in at least one axial section, with a profile for forming a circular wedge connection through a relative rotational movement between the bolt and the receptacle.

By pressing the centering bushing into the centering section, the components, which are to be coupled to one another, are aligned precisely with respect to one another and bear against one another—directly or indirectly—in a defined fashion, the articulated connection being made free of play in the axial and radial directions. The axial force pushes the centering bushing into the centering section and, as a result, the second component is pressed indirectly or directly against the first component. The level of the axial force makes it possible to set precisely the friction which acts between the components and has to be overcome when these components are pivoted with respect to one another.

The axial force that acts on the centering bushing can be set independently of the securing force of the locking element, which secures the locking element on the bolt in a precisely positioned fashion. This is the case because, in contrast to a screw/nut connection, a specific frictional torque does not have to act on the end bearing contact surfaces of the centering bushing and the locking element in order to secure the locking element on the bolt in the desired axial position. Due to the configuration according to the present invention, the resulting flexural torque of the components, which are pivotably connected to one another, and the securing force of the articulated connection can easily be set independently of one another.

Circular wedge connections of the type mentioned here are known, for example, from German patent documents DE 42 31 320 C2, DE 196 25 554 C2 and DE 42 09 153 C3. With respect to the design and functioning of the circular wedge connection, the contents of these documents are incorporated into the present application. The circular wedge connection used in conjunction with the device according to the present invention is therefore formed by at least one wedge-shaped elevation, which projects radially over the circumferential surface of the bolt, and by at least one wedge-shaped recess of corresponding design, which is provided in the receptacle circumferential surface. The elevation and the recess are engaged with each other by a relative rotational movement between the bolt and locking element. An existing frictionally locking/positively locking connection may be released for the purpose of disassembly.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a perspective illustration of an exemplary embodiment of the device according to the present invention in the mounted state; and

FIGS. 2 to 4 show views of the device according to FIG. 1 in different phases of assembly.

### DETAILED DESCRIPTION OF THE DRAWINGS

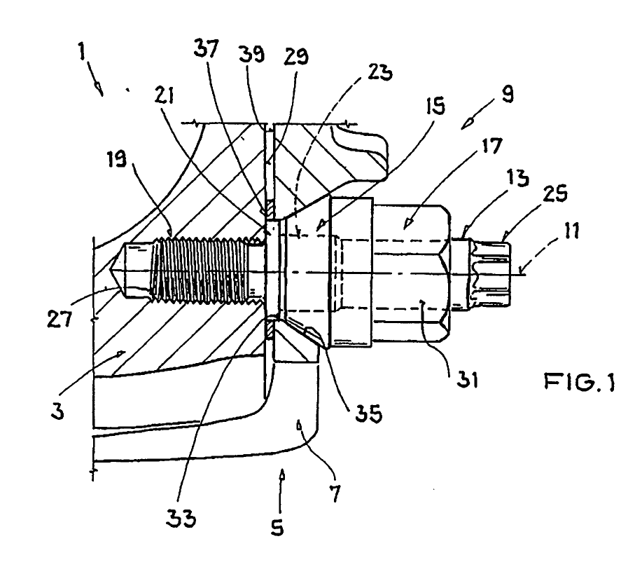

FIG. 1 shows a detail of an exemplary embodiment of a steering column arrangement 1 for a motor vehicle which includes a steering column (not illustrated) with adjustable inclination, a steering column jacket 3 and an inclination adjustment device 5. In the illustration of the adjustment device 5 according to FIG. 1, only part of a lever 7 can be seen, which lever 7 is connected to the steering column jacket 3 (of which only a portion is also illustrated), so as to be capable of pivoting about an axis 11 by means of a device 9 for forming an articulated connection between the components. Between the essentially U-shaped lever 7 and the steering column jacket 3 in this exemplary embodiment, there is a further articulated connection (not shown in the figures), which is of identical design to the articulated connection illustrated in FIG. 1 and implemented of the device 9.

The device 9 includes a bolt 13, a centering bushing 15 and a locking element 17.

The bolt 13 has a first longitudinal section 19 provided with an external thread and adjoined by a second longitudinal section 21 with a relatively large diameter provided on its annular end surface—facing the steering column jacket 3 in the mounted state—with a locking toothing. The second longitudinal section 21 is adjoined by a third longitudinal section 23 with a relatively small diameter, which is adjoined in turn by a relatively short, fourth longitudinal section 25, which is embodied as a polygon. A torque for screwing the first longitudinal section 19 into and out of a corresponding threaded bore can be applied to the fourth longitudinal section by a tool. In this exemplary embodiment, the second longitudinal section 21 and the third longitudinal section 23 have a circular cross section. The bolt 13 is screwed, in the mounted state, with its first longitudinal section 19 having the external thread into a threaded bore 27 which is provided on the steering column jacket 3. The bolt 13 is screwed in until the circular annular surface of the second longitudinal section 21, which is provided with the locking toothing, bears against or is pressed against a contact surface 29, which is arranged on the steering column jacket 3. A screw-in limitation is implemented by the jump in diameter between the longitudinal sections 21 and 23.

The centering bushing 15 is formed here by a conical bushing having a frustum-shaped base body, which is provided in the direction of its longitudinal center axis with a circular through-opening for leading through the bolt 13. The through-opening which is formed, for example, by a cylinder bore in the centering bushing 15 has a larger diameter than the third longitudinal section 23 of the bolt 13 in the region of the axial position of the centering bushing 15 in the mounted state. That is, the centering bushing 15 may be plugged with little play onto the third longitudinal section 23 of the bolt 13 to compensate manufacturing and positional tolerances, and to facilitate assembly.

The locking element 17 is embodied in a bushing and has a receptacle for the bolt 13. The receptacle is formed here by a through-opening so that, in the mounted state of the locking element 17, the bolt 13 projects through the receptacle of the locking element 17, as illustrated in FIG. 1. Both the circumferential surface of the bolt 13 and the internal surface of the receptacle of the locking element 17 are provided in at least one axial section which, in the case of the bolt 13, is located in the region of the third longitudinal section 23, with a profile in order to form a circular wedge connection through a relative rotational movement between the bolt 13 and receptacle.

The relative rotational movement occurs in the clockwise direction or anticlockwise direction about the axis 11 depending on the design of the circular wedge connection. Such a circular wedge connection is known, for example, from the documents mentioned in paragraph [009], and thus only a short introduction is given here. The circular wedge connection is formed by at least one wedge-shaped elevation, which projects radially over the circumferential surface of the bolt, and by at least one wedge-shaped recess of corresponding design, which is arranged in the receptacle circumferential surface.

In one exemplary embodiment of the device 9, two wedge-shaped elevations and, accordingly, two wedge-shaped recesses are provided, which permits high pressure per unit of surface area in the contact region. In order to tighten or release the circular wedge connection between the locking element 17 and bolt 13, the locking element 17 can be turned about the axis or pivoted within a small angular range. For this purpose, the locking element 17 is provided on its external circumferential surface with a longitudinal section, which is provided with an hexagon external bit 31, against which a tool, such as an open-end wrench, of corresponding design can be fitted to the locking element 17 in order to apply a tightening or release torque to it.

As is apparent from FIG. 1, the lever 7 of the inclination adjustment device 5 has a through-opening which the bolt 13 engages through in the mounted state of the device 9. The through-opening in the lever 7 has a first longitudinal section 33 with a cross section which is circular and which is adjoined by a conical centering section 35. The centering section 35 is matched to the external contour of the centering bushing 15 in shape and size in such a way that in the mounted state of the device 9 the centering bushing 15 bears in a planar fashion against the centering section 35 of the through-opening. As is apparent from FIG. 1, the internal diameter of the first longitudinal section 33 of the through-opening is larger than the external diameter of the bolt 13 in the region of its second longitudinal section 21, which projects into the first longitudinal section 33 of the through-opening in the mounted state of the device 9.

A sliding washer 37 is arranged between the steering column jacket 3 and the lever 7. In the mounted state of the device 9, the sliding washer 37 is arranged between the contact surface 29 on the steering column jacket 3 and a corresponding contact surface 39 arranged on the lever 7. The sliding washer 37 is clamped in between these surfaces by the axial force transmitted by the locking element and the centering bushing. The steering column jacket 3 and the lever 7 are held apart from one another at a desired distance of the sliding washer 37. Furthermore, the sliding washer 37 ensures a defined frictional surface with the desired properties between these components.

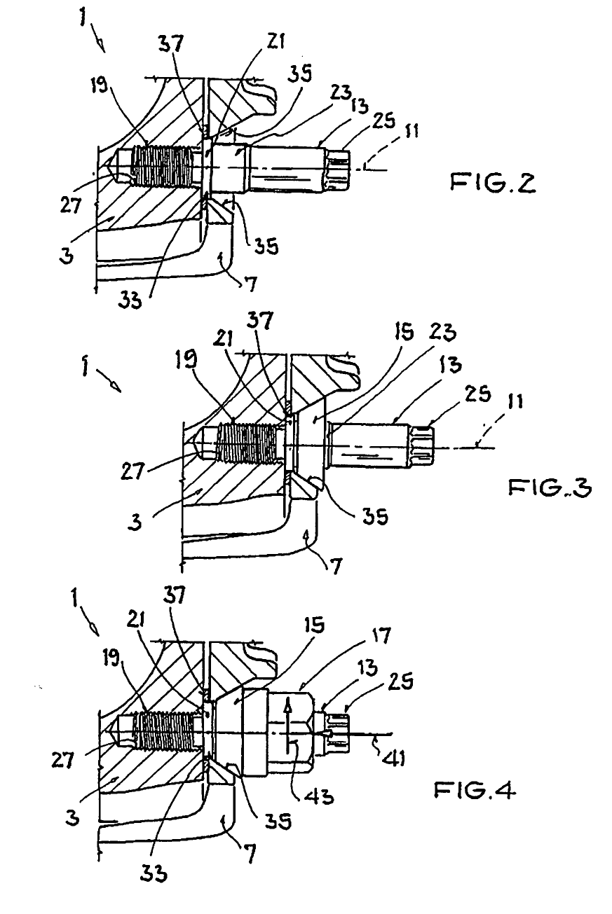

In the text which follows, the function of the device 9 described above and the assembly method according to the invention will be explained in more detail with reference to FIGS. 2 to 4.

As is apparent from FIG. 2, the bolt 13 is first screwed with its threaded section 19 into the threaded bore 27 in the first component, i.e., the steering column jacket 3, until the end annular surface of the second longitudinal section 21 bears against the contact surface 29 of the steering column jacket 3 or is pressed against it with a specific axial force. This prevents undesired release of the screw connection. The jump in diameter between the first and second longitudinal sections of the bolt 13 simultaneously provides a screw-in limitation. The sliding washer 37 is pushed onto the second longitudinal section 23 of the bolt 13.

The steering column jacket 3 and the lever 7 are then plugged together in such a way that the bolt 13 engages through the stepped through-opening in the lever 7. This first brings about coarse alignment of the components 3 and 7 with one another. The centering bushing 15 then may be pushed onto the bolt 13 with its diameter at the smaller end at the front and may be moved into the centering section 35 of the through-opening in the lever to such an extent that the external circumferential surface of the conical centering bushing comes into bearing contact with the centering section 35 of complementary design. As a result, the components 3 and 7 are aligned precisely in the radial direction, that is to say perpendicularly to the axis 11. This phase of assembly is illustrated in FIG. 3.

The locking element 17 is then pressed onto the bolt 13 and pressed with a predefined axial force 41 at the end against the end surface of the centering bushing 15 with a relatively large diameter, as is indicated in FIG. 4 with an arrow. This axial force 41 causes the centering bushing 15 to be pressed in a defined fashion into the centering section 35, which in turn causes the lever 7 to be moved against the sliding washer 37, which is arranged between the components 3 and 7 and is supported on the contact surface 29. As a result, the connection between the components 3 and 7 is then also free of play in the axial direction.

The level of the axial force 41 is set as a function of the desired flexural torque between the components 3 and 7. Finally, when the axial pressing-on force 41 is applied, the circular wedge connection is formed between the locking element 17 and the bolt 13 through a rotational movement of the locking element 17 relative to the bolt 13, as indicated by an arrow 43. The assembly process is thus terminated and the articulated connection is formed between the components 3 and 7 with the required parameters.

To summarize, it is to be noted that the articulated connection between the components 3 and 7 described above with reference to the figures is free of play in the axial and radial directions. In addition, the assembly pressing-on force 41 and the locking torque 43, which both act simultaneously on the locking element 17, can be freely selected independently of one another. The play-free, secure and rigid rotational connection which is implemented by the device according to the invention with a flexural torque between the components 3 and 7 which can be set by the pressing-on force 41 has only a small number of components and can be manufactured with a small number of assembly steps.

The use of the device 9 is not restricted to the application described in the context of a steering column arrangement for a motor vehicle with reference to the figures but rather can also be used elsewhere, where two components are to be connected to one another in a detachable and pivotable fashion and the flexural/frictional torque between these components which has to be overcome in order to pivot them is to be settable independently of the securing force of the device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for a detachable and pivotable connection of at least two components, comprising:
a bolt provided on a first component, the bolt engaging a second component through a through-opening in the second component, wherein,
the through-opening has a centering section into which a centering bushing, which is plugged onto the bolt, engages;
the centering bushing is pressed onto the centering section to set a defined frictional torque between the first and second components with a predefined axial force;
a locking element, which is plugged onto the bolt and has a receptacle for the bolt, secures the axial position of the centering bushing; and
both a circumferential surface of the bolt and an internal surface of the receptacle have, in at least one axial section, a profile for forming a circular wedge connection through a relative rotational movement between the bolt and the receptacle.

2. The device according to claim 1, wherein the centering bushing is pushed by the locking element with a predefined axial force against the centering section to set a defined frictional torque between the first and second components.

3. The device according to claim 1, wherein the circular wedge connection is formed by at least one wedge-shaped elevation, which projects radially over the circumferential surface of the bolt, and at least one wedge-shaped recess corresponding to the wedge-shaped elevation in a receiving circumferential surface.

4. The device according to claim 1, wherein the first and second components are in bearing contact against each other, or a sliding washer is arranged between the first and second components.

5. The device according to claim 1, wherein the first component is a steering column jacket of a motor vehicle steering column having adjustable inclination, and the second component is a lever element of an inclination adjusting device of the steering column.

6. The device according to claim 2, wherein the circular wedge connection is formed by at least one wedge-shaped elevation, which projects radially over the circumferential surface of the bolt, and at least one wedge-shaped recess corresponding to the wedge-shaped elevation in a receiving circumferential surface.

7. The device according to claim 2, wherein the first and second components are in bearing contact against each other, or a sliding washer is arranged between the first and second components.

8. The device according to claim 3, wherein the first and second components are in bearing contact against each other, or a sliding washer is arranged between the first and second components.

9. The device according to claim 2, wherein the first component is a steering column jacket of a motor vehicle steering column having adjustable inclination, and the second component is a lever element of an inclination adjusting device of the steering column.

10. The device according to claim 3, wherein the first component is a steering column jacket of a motor vehicle steering column having adjustable inclination, and the second component is a lever element of an inclination adjusting device of the steering column.

11. The device according to claim 4, wherein the first component is a steering column jacket of a motor vehicle steering column having adjustable inclination, and the second component is a lever element of an inclination adjusting device of the steering column.

12. A method for mounting a device for a detachable and pivotable connection of at least two components, the method comprising:
inserting a bolt provided on a first component into a through-opening provided on a second component;
pushing a centering bushing onto the bolt;
pushing a locking element having a receptacle for the bolt onto the bolt;
orienting the first and second components with one another by moving the centering bushing into a centering section of the through-opening;
setting desired flexural torque between the first and second components by moving the locking element against the centering bushing by applying a defined pressing-on force to the centering bushing in the axial direction; and
securing the locking element to the bolt with a relative rotational movement between the bolt and the receptacle to form a circular wedge connection.

13. The method according to claim 6, wherein the flexural torque which is to be applied to pivot the first component with respect to the second component is set by setting the force which presses the centering bushing into the centering receptacle.
